(19) United States
(12) Patent Application Publication
(10) Pub. No.: US 2008/0264987 A1
(43) Pub. Date: Oct. 30, 2008

(54) Container for use with a vehicle seat

(76) Inventors: Mitchell J. Sarro, Hauppauge, NY (US); John R. Williams, Baldwin, NY (US)

Correspondence Address: Daniel P. Burke, Esq.;Daniel P. Burke & Associates, PLLC, Suite 131, 300 Rabro Drive, Hauppauge, NY, 11788, US

(21) Appl. No.: 12/004,724

(22) Filed: Dec. 21, 2007

Related U.S. Application Data
(60) Provisional application No. 60/925,973, filed on Apr. 24, 2007.

(51) Int. Cl. B60R 7/04; B65D 25/00

(52) U.S. Cl. 224/275; 220/694

(57) ABSTRACT

Containers for use with a vehicle seat of the type comprising a backrest with at least a forward surface and a rear surface, a seat cushion having at least an upper surface and a rear surface, and a slot between the backrest and the seat cushion. The container comprises a housing and an attachment member for securing the housing to the seat, having a rearward distal portion which extends rearwardly and then either upwardly or downwardly to engage a rear surface of at least one of the backrest or the seat cushion. The rearward distal portion is preferably resilient. Also disclosed is a disposable attachment member designed for attachment to a separate container, such as a pizza box. The attachment member advantageously comprises a connector portion such as a release strip covering an adhesive portion designed to be connected to the separate container.

### RELATED APPLICATION DATA

This application claims the benefit under 35 U.S.C. § 119(e) of U.S. Provisional Application Serial No. 60/925,973, filed April 24, 2007, which is hereby incorporated by reference as if repeated herein in its entirety.

The present invention is directed to a container useful in a vehicle and, more particularly, to a container which is readily attachable and detachable from a vehicle seat comprising a backrest, a seat cushion and a slot between the backrest and seat cushion.

### BACKGROUND OF THE INVENTION

People operating motor vehicles, particularly automobiles, SUV's, and trucks, are often carrying miscellaneous articles such as cell phones, PDA's, wallets, fast food containers such as cups, preformed cup trays for holding multiple cups, food containers such as pizza boxes, and the like. Many vehicles do not have receptacles for securely maintaining such articles in position during stop and go driving, particularly with respect to larger items such as multiple cup trays, pizza boxes, etc.

Additionally, many people operate their vehicles alone, i.e. without any passengers, for a significant portion of their driving time. Such people, including salespeople and truck drivers, often do not have a means to readily secure their papers or other articles which they would like to have readily accessible while either driving or when making brief stops.

Various devices have been suggested for addressing the need of a container which secures articles within a moving vehicle. Some suggestions have included various types of coolers and consoles attachable to vehicle seats, however, such designs either require belts or ropes for attachment to the vehicle or appear to lack sufficient means for securing the container to many seats, particularly leather seats, and when holding articles weighing several pounds, such as a full, multiple-drink tray, during a sudden stop.

It is therefore desirable to provide a container for use with a vehicle seat which is readily and quickly both attachable and detachable from a vehicle seat when desired without the need for supplemental restraints such as straps or belts. It is also desirable to provide a container particularly suited for securing articles of different shapes and sizes.

### SUMMARY OF THE INVENTION

Various embodiments of the present invention are directed to containers for use with a vehicle seat of the type comprising a backrest with at least a forward surface and a rear surface, a seat cushion having at least an upper surface and a rear surface, and a slot between the backrest and the seat cushion. The slot can normally be closed, i.e. the backrest and seat can normally be in contact, but, as in many modern vehicles, a relatively thin item can be passed through the slot defined between the backrest and seat cushion.

According to one embodiment of the present invention, the container comprises a housing and an attachment member for securing the housing to the seat. According to this embodiment, the securing member comprises a resilient fluke, preferably formed of a resilient material having a portion which can open in response to a forward force to engage a surface of at least one of the backrest or the seat cushion.

According to one preferred embodiment, the securing member is formed of a resilient material, such as corrugated plastic, and comprises a distal portion folded back and secured upon itself proximate the side edges of the securing member. According to this embodiment, at least a central portion of the rearward portion of the securing member is sufficiently resilient to facilitate insertion into a relatively tight slot between a backrest and seat cushion, but after insertion into the slot in the rearward direction, a slight forward motion will cause the fluke on the distal portion of the securing member to dig into at least one of the seat cushion or the backrest. This tightening engagement with at least one of the seat cushion or the backrest in response to a forwardly directed force prevents unintended dislodgements during a sudden stop of the vehicle. Thus, when the housing of this preferred embodiment is positioned in a generally horizontal position, the securing member is slightly tensioned in order to better engage with the rear surface of the seat cushion or backrest.

Other embodiments of the present invention comprise securing members or anchor members with distal portions in the form of flukes at angles of about 20 degrees to less than about 90 degrees.

Another embodiment of the present invention comprises a disposable attachment member designed for attachment to a separate container, such as a pizza box. The attachment member advantageously comprises a connector portion such as a release strip covering an adhesive portion designed to be connected to the separate container, e.g. pizza box, an intermediate portion which passes into the slot defined between a vehicle backrest and seat cushion, and a distal anchor portion with a resilient fluke which engages the surface of at least one of the seat cushion or backrest.

### BRIEF DESCRIPTION OF THE DRAWINGS

FIG. 1 is a front, top perspective view of one embodiment of the present invention.

FIG. 2 is a cross sectional view taken along lines 2-2 of FIG. 1.

FIG. 3 is a rear, upper perspective view of a portion of the container of FIG. 1.

FIG. 4 is a partial, rear lower perspective of the container of FIG. 1.

FIG. 5 is a top, rear perspective of the container of FIG. 1.

FIG. 6 is a rear, upper perspective view of the container of FIG. 1 with different sized cup holders shown in phantom.

FIG. 7 is a partial rear plan view of the container as shown in FIG. 6.

FIG. 8 is a partial front plan view of the container shown in FIG. 6.

FIG. 9 is a perspective view of the container of FIG. 6 attached to a seat.

FIG. 10(A) is a partial side view of the container shown in FIG. 1 drawing attachment to a vehicle seat.

FIG. 10(B) is a close up of the rearward distal portion of the retaining member and seat cushion in the configuration shown in FIG. 10(A).

FIG. 11(A) is a side view of the container of FIG. 1 in position on a vehicle seat.

FIG. 11(B) is a close up of the rearward distal portion of the retaining member and seat cushion in the configuration shown in FIG. 11(A).

FIG. 12(A) is a partial side view of the container shown in FIG. 1 drawing attachment to a vehicle seat.

FIG. 12(B) is a close up of the rearward distal portion of the retaining member and seat cushion in the configuration shown in FIG. 12(A).

FIG. 13(A) is a side view of the container of FIG. 1 in position on a vehicle seat.

FIG. 13(B) is a close up of the rearward distal portion of the retaining member and seat cushion in the configuration shown in FIG. 13(B).

FIG. 14 is a rear view of an alternative embodiment of the present invention.

FIG. 15 is a rear view of an alternative embodiment of the present invention.

FIG. 16 is a top plan view of an alternative embodiment of the present invention with a pizza box shown in phantom.

FIG. 17 is a side view of the embodiment shown in FIG. 16.

FIGS. 18 and 19 are upper and lower perspective views of embodiments similar to FIGS. 16 and 17 attached to the bottom of a container shown in phantom.

### DETAILED DESCRIPTION

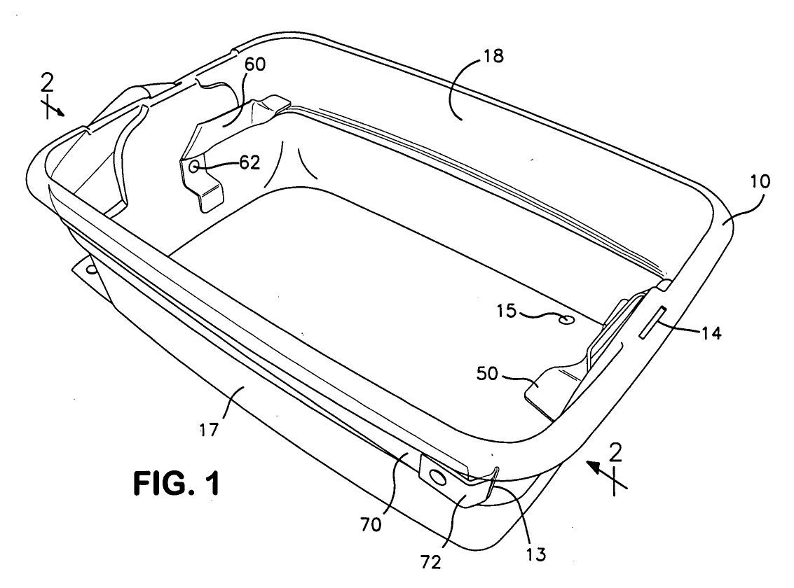

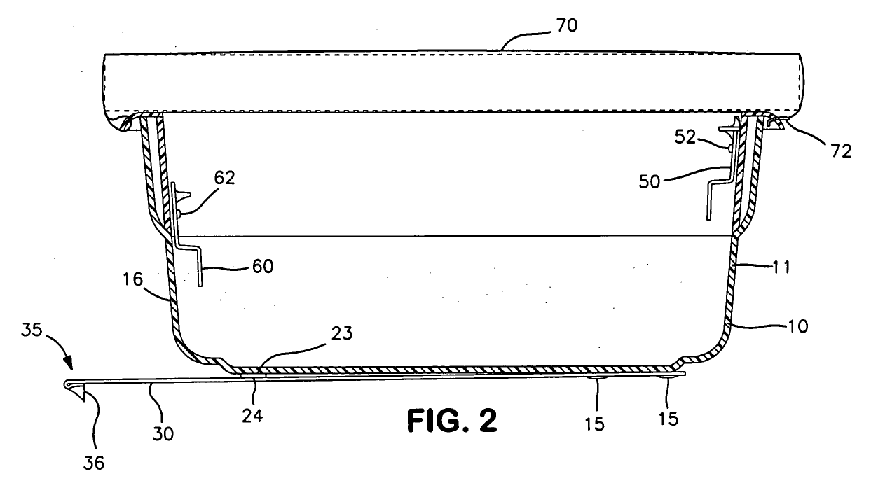

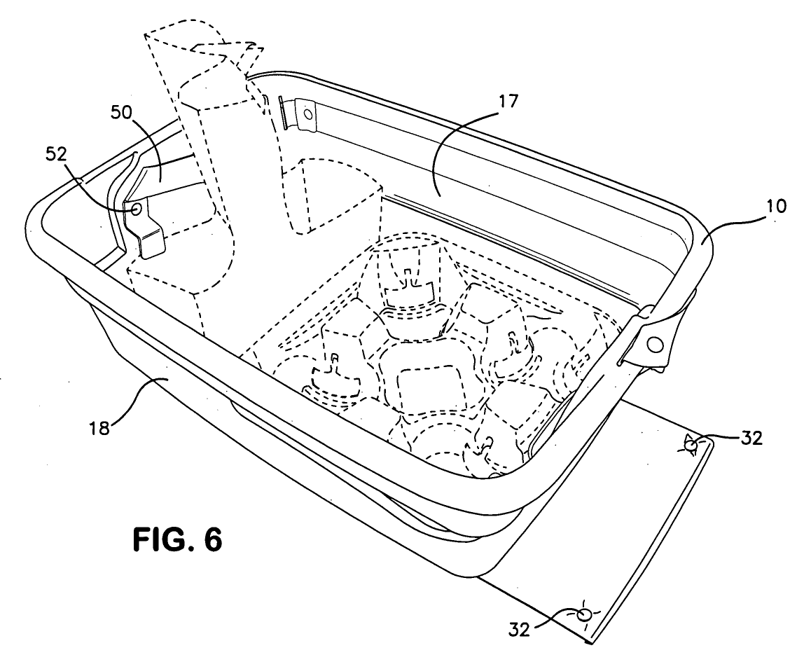

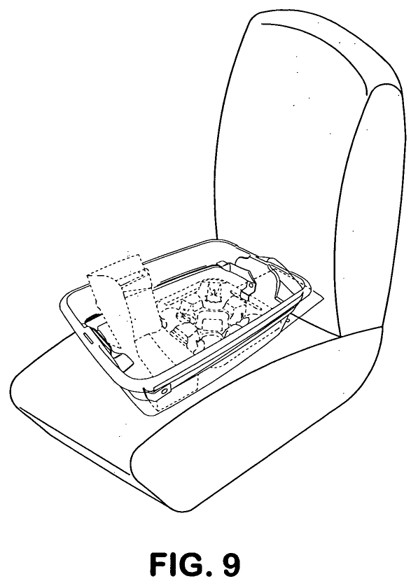

FIGS. 1-13 illustrate one embodiment of the present invention comprising a container which is particularly useful for securing items during operation of a vehicle and which is readily attachable to and detachable from a vehicle seat comprising a backrest, a seat cushion and a slot between the backrest and seat cushion. With reference to FIGS. 1 and 2, this illustrated embodiment of the present invention comprises a housing comprising a forward wall 11, rear wall 16, right wall 17 and left wall 18. A retaining member 30 is movably attached to housing 10 with a plurality of rivets positioned in a forward portion of the container and corresponding hook and fastener strips 23 and 24 proximate a rearward portion of housing 10. In this illustrated embodiment, housing 10 is generally in the form of a transparent tub comprising four walls, a bottom and an open top. Other forms of housings including a tote, an oval, a closable container, and multiple compartments can be used. The illustrated housing 10 is designed to hold various common items which might otherwise be placed on a vehicle seat and remain unrestrained during operation of the vehicle, such as pens, PDA's, cell phones, toys, files, etc.

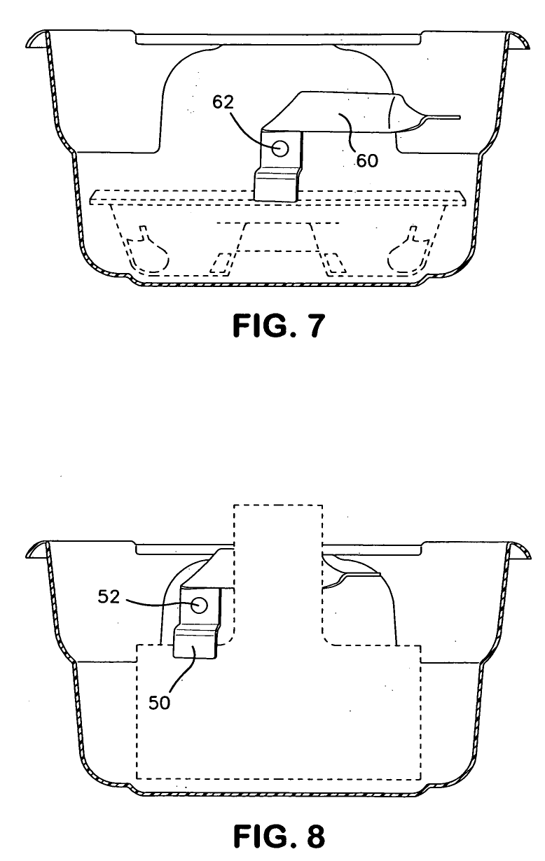

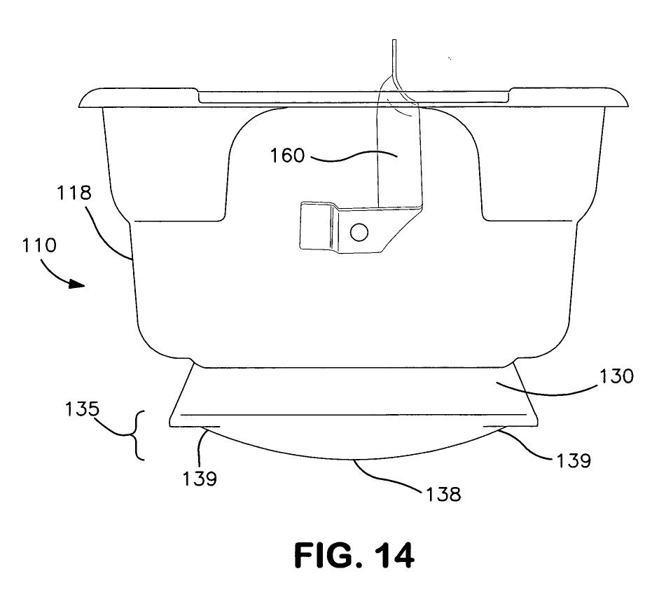

According to one aspect of this embodiment, a plurality of latches are connected to housing 10 and positioned to secure items at different heights. In this illustrated embodiment, forward latch 50 is rotatably connected to forward housing wall 11 and rotatable about a rivet 52. A second latch 60 is rotatably connected to rear housing wall 16 by a rivet 62 and movable between a latched position shown in FIGS. 2 and 7 and an unlatched position shown in FIG. 14 (in an alternative embodiment).

While this illustrated embodiment shows latches which are rotatable, other types of latches can be used without departing from the scope of the present invention. It is also within the scope of the present invention to position the latches on different portions of the housing, on the same walls, as well as on exterior walls. It is also within the scope of the present invention to use latches which do not rotate, such as spring-biased clips.

The container of this embodiment of the present invention is generally shown in a storage position in FIG. 2. In this storage configuration, retaining member 30 is advantageously maintained proximate housing 10 with the cooperating hook and loop fastener strips 23 and 24. When it is desired to secure the housing to a vehicle seat, adjacent strips 23, 24 are simply separated to allow the rearward portion of retainer 30 to move downwardly relative to housing 10.

This embodiment of the present invention comprises a retaining member 30 having a rear distal portion 35 which extends into, and optionally, through the slot formed between the bottom of a vehicle seat backrest and the top of a seat cushion. As used herein, the term “slot” is not intended to indicate that a space or visible gap normally exists between the bottom of the backrest and the top of the seat cushion. Those skilled in the art will appreciate that modern vehicles often comprise backrests which are normally in contact with seat cushions. However, moderate force permits insertion of relatively thin items into this slot due to the resiliency of the cushions.

The rearward distal portion of the retainer 30 comprises a resilient fluke designed to pass into the slot between a vehicle seat backrest and seat cushion. Depending upon the front-to-rear depth of the slot, the rearward distal portion will extend into the slot. In instances where the distal portion does not extend out the back of the slot, the resilient fluke will tend to open and bite into one of the backrest or cushion when a forwardly directed force is placed on the retainer. Alternatively, if the rearward distal portion extends beyond at least one of the back of the backrest or the back of the seat cushion, the resilient fluke of the rearward distal portion 35 engages at least one of the rearward surfaces of the seat cushion or the backrest.

According to the embodiment illustrated in FIG. 2, the retaining member 30 is formed of a resilient material, such as corrugated plastic. As best shown in FIG. 4, the distal edge 36 of the retainer is folded back under another portion of the retainer 30 and secured in placed with rivets 32 positioned proximate the side edges of retainer 30. According to one preferred embodiment, a resilient material such as corrugated plastic is used to form at least part of the retaining member. Due to the inherent resiliency of the material used to form retainer 30, a central portion 38 of this rearward distal portion 35 will extend downwardly to an extent which is lower than the edge portions 39. Since the central portion 38 is not secured with a rivet or the like, the rearward distal portion 35 will normally assume a configuration such as that shown in FIG. 2 with the edge 36 forming a forward facing abutment surface.

When retainer 30 is inserted into the slot between a backrest and seat cushion, the natural resiliency of the retainer will allow the rearward distal portion 35 to collapse as needed in order to facilitate insertion of the retaining member 30 into or through the slot between the backrest and seat cushion. When a slight forward motion is applied to rearward distal portion 35, rearward distal portion 35 will open to an uncompressed position thereby causing the fluke to dig into the cushion or forward facing surface 36 to engage the back of a seat cushion.

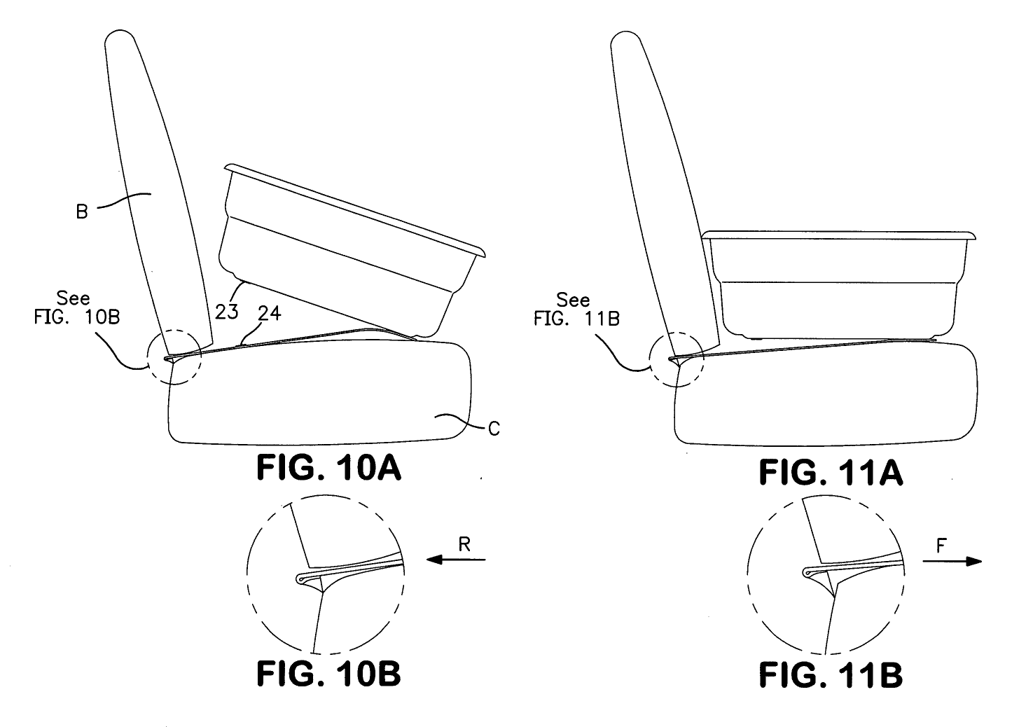

FIGS. 10(A) and 10(B) illustrate this embodiment of the present invention partially installed between a vehicle backrest B and seat cushion C. As shown in FIG. 10 (b), rearward distal portion 35 of retainer 30 has the same general configuration as shown in the storage configuration of FIG. 2. FIGS. 11(A) and 11(B) illustrate this preferred embodiment in an operative position. According to this preferred embodiment, when housing 10 is lowered into the operative position shown in FIG. 11(A), a slight forward motion is applied to retainer 30 in the direction of Arrow F, and the rearward distal portion 35 and particularly distal edge 36 is caused to bear more forcibly on the rear surface of seat cushion C thereby deforming rearward distal portion 35 to force the lower extremity of this ledge 36 to move downwardly, i.e. further away from the upper portion of retainer 30. This provides a more secure attachment of the container to the seat.

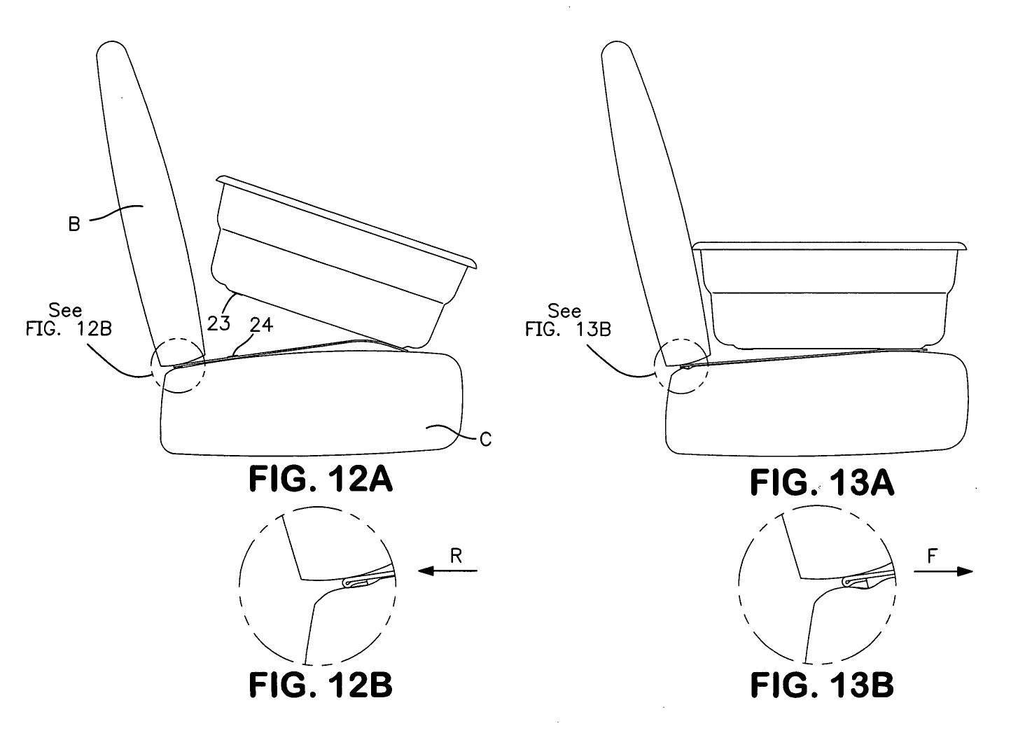

FIGS. 12(A) and 12(B) illustrate another installation of this embodiment of the present invention wherein the retainer extends only partially through the slot between vehicle backrest B and seat cushion C. As shown in FIG. 12(B), rearward distal portion 35 of retainer 30 is slightly compressed relative to the same general configuration as shown in the storage configuration of FIG. 2. This Figure illustrates the resilient fluke during or at the end of the rearwardly directed insertion. FIGS. 13(A) and 13(B) illustrate this preferred embodiment in an operative position after a slight forward motion. According to this preferred embodiment, when housing 10 is lowered into the operative position shown in FIG. 13(A), the rearward distal portion 35 and particularly distal edge 36 moves forwardly in the direction of Arrow F is caused to bear more forcibly on the upper surface of seat cushion C thereby deforming rearward distal portion 35 and tending to open the fluke and to force the lower extremity of this ledge 36 to move downwardly, i.e. further away from the upper portion of retainer 30. This provides a more secure attachment of the container to the seat.

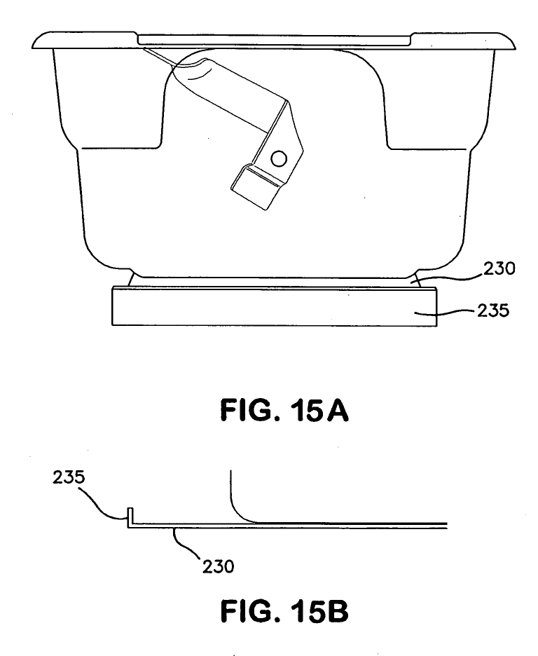

While the present embodiment illustrates the rearward distal portion extending downwardly for better engagement with the upper or rear surface of the seat cushion C, according to another embodiment of the present invention shown in FIGS. 15(A) and 15(B), the retainer engages the backrest B when properly connected to a vehicle seat.

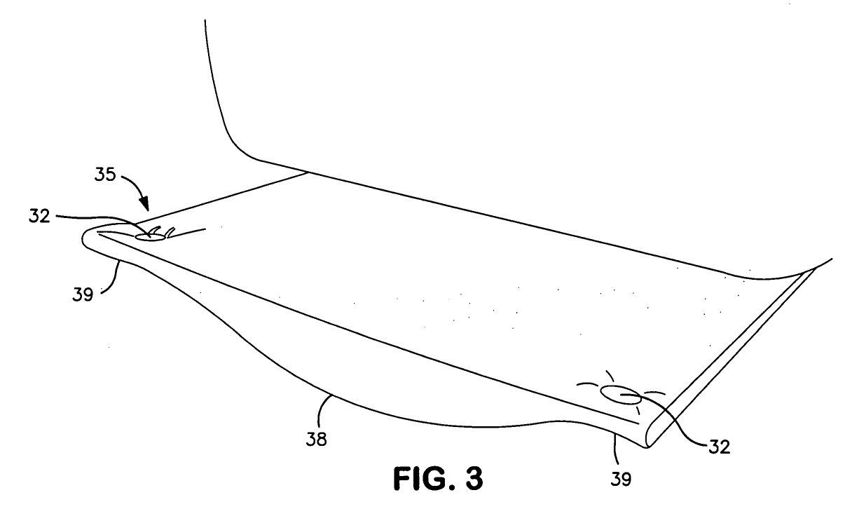

With reference to FIG. 3, when is it is desired to remove the container from a vehicle seat, the container is first pushed to one side, i.e. either the left or right, thereby causing one of the side portions 39 of rearward distal portion 35 to become a somewhat leading portion of rearward distal portion 35. Since these side portions of rearward distal portion 35 do not extend downwardly as far as central portion 38, the narrower, leading edge of rearward distal portion 35 will lead this distal portion 35 back out of the slot and tend to cause central portion 38 to compress to any extent which might be needed for removal.

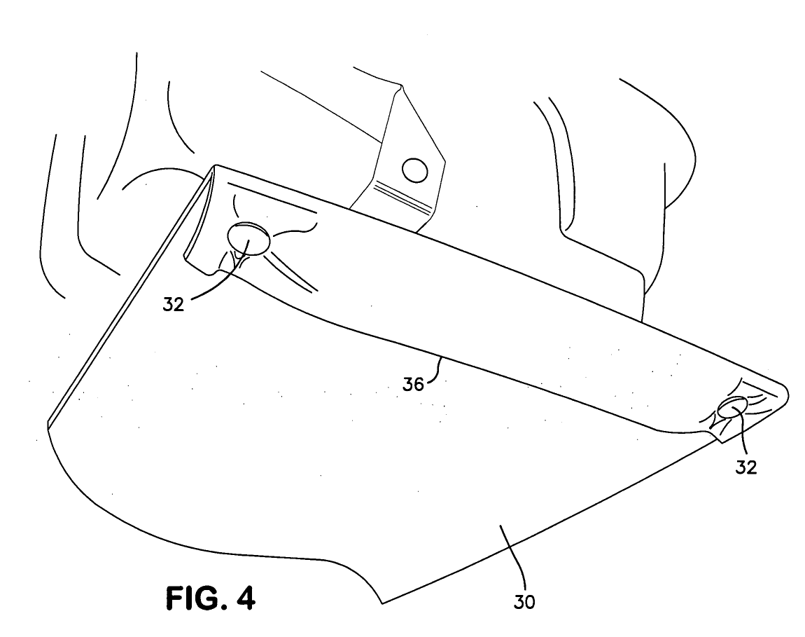

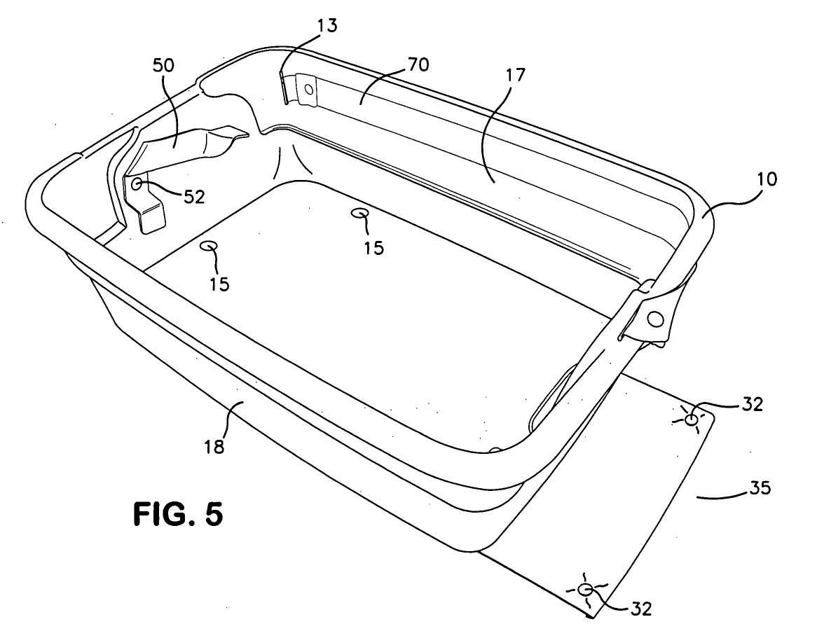

Another aspect of this illustrated embodiment is the provision of an elastic retainer 70 shown in the storage position in FIG. 1 and in the operative position over a box, such as a pizza box (shown in phantom in FIG. 2). Elastic retainer 70 advantageously comprises a hook 72 positioned at the distal, free end thereof. In this preferred illustrated embodiment, the proximal end of elastic retainer 70 is permanently connected to the housing 10 as best shown in FIG. 5, however, it is also within the scope of the present invention to have the proximal end of elastic retainer 70 removably attached to the housing 10. Housing 10 is provided with a plurality of attachment members, in this embodiment a plurality of slots, designed to securely receive retaining hook 72. As shown in FIG. 1, housing 10 comprises a corner slot 13 for securing elastic retainer 70 in a storage position which is out of the way and keeps elastic retainer 70 from dangling when not in use. Housing 10 also comprises a forward slot 14 formed in the upper rim of forward wall 11 for securely receiving hook 72 when elastic retainer 70 is used to secure an item on top of housing 10 as shown in FIG. 2. While illustrated as a generally flat, elongated strap, retainer can also be in the form of a bungee cord, a ratcheting strap, a non-elastic strap or a D-ring buckle strap.

FIG. 14 illustrates an alternative embodiment of the present invention which is similar to the embodiment shown in FIGS. 1-13, however the retainer 130 is formed of a moldable plastic such as polyethylene, polypropylene, a PVC. Other retainers can be formed of cardboard, either corrugated or non-corrugated. As shown in the rear view of FIG. 14, the rearward latch 160 is positioned in the unlatched position.

FIG. 15 shows a still further embodiment of the present invention wherein the retaining member 230 is formed of a thermoplastic and comprises a generally rectangular rear profile. The downward extending portion 235 extends upwardly that is shown in FIG. 15(B).

FIG. 14 illustrates an alternative embodiment of the present invention. In this embodiment, the housing 110 is identical to the housing shown in FIGS. 1-13. In FIG. 14, latch 160 is shown in a rotated or retracted, inoperative position relative to the multi-cupholders shown in the embodiment discussed above. It is also possible to use latch 160 in the position shown in FIG. 14 to hold an item close to the left wall 118 of housing 110. As indicated, the configuration of the rearward distal portion 135 of retaining member 130 extends downwardly to a greater extent in a center section 138 than at edge portions 139 in order to facilitate removal of the container from a vehicle seat as discussed above.

FIGS. 15(A) and 15(B) illustrate a still further embodiment of the present invention. According to this embodiment, the distal portion 235 of retaining member 230 extends upwardly to engage the rearward surface of a vehicle backrest when in use. Additionally, this embodiment illustrates another configuration of the rearward distal portion 235 which is generally rectangular.

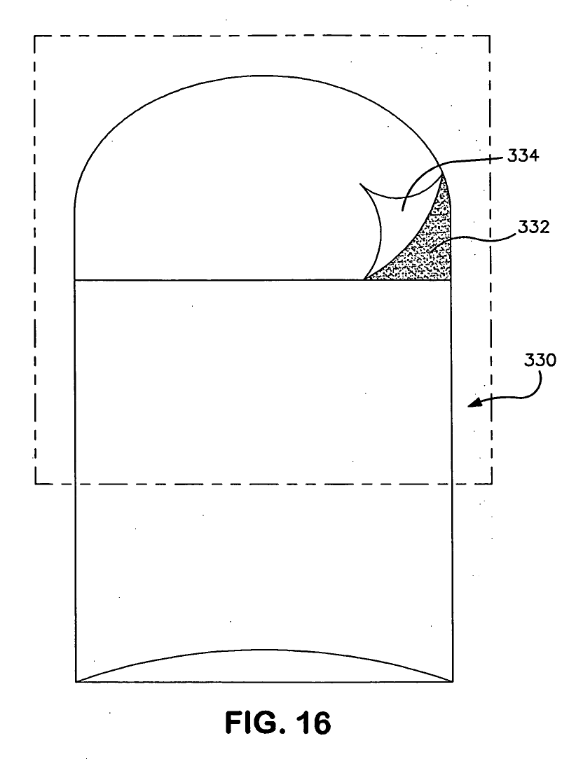

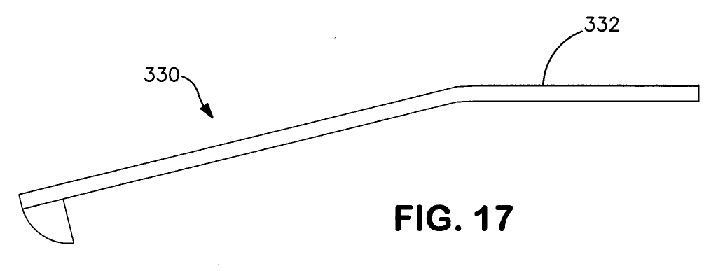

According to alternative embodiments shown in FIGS. 16-19, a retaining member 330 is provided with a self sticking adhesive portion 332 covered by a peel away strip 334. According to this embodiment, the retainer 330 can have the shape of one of the previously disclosed retaining members but this retaining member 330 is designed to be attached to a container, such as a disposable container. For example, a disposable container such as a pizza box, which is normally discarded after a single use, is an item which is often carried in a vehicle when a consumer buys a pizza and brings it home for consumption. According to this embodiment of the present invention, if the consumer so desires, a retainer 330 can be readily and quickly attached to the bottom of the pizza box by simply peeling away the protective strip 334 and pushing the then exposed adhesive portion 332 onto the bottom of the pizza box. Prior to attachment, the retaining member generally takes the shape shown in FIG. 17.

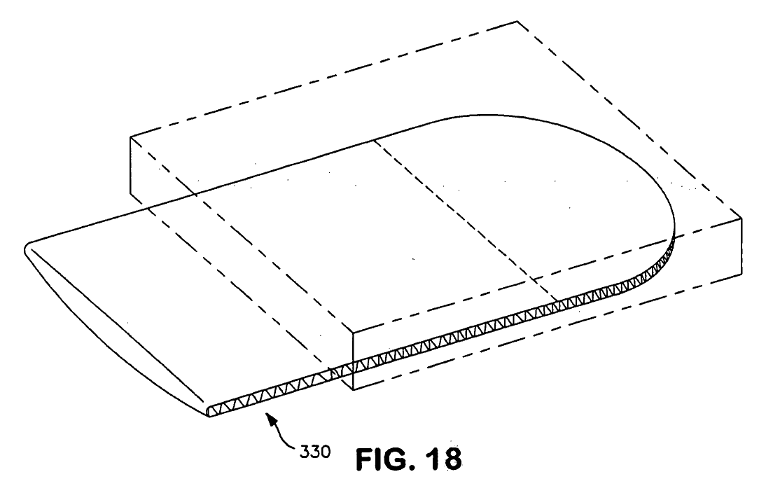

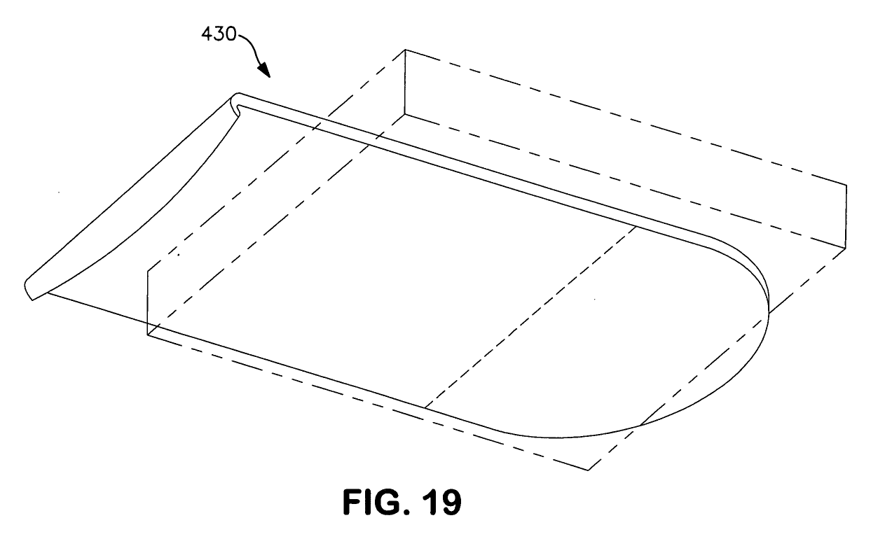

Alternatively, the retaining member can simply be folded up under the bottom of the disposable container as shown, for example, in FIGS. 18 and 19 which are top perspective views and bottom perspective views respectively of two embodiments with a pizza box shown in phantom. The embodiment shown in FIG. 18 is formed of corrugated cardboard and the retaining member 430 shown in FIG. 19 is formed of a non-corrugated cardboard, thermoplastic resin, or other material.

According to this embodiment of the present invention, the retaining member is preferably formed of cardboard, such as corrugated cardboard or non-corrugated cardboard. According to another embodiment, the retaining member is formed of thermoplastic material which may or may not be recyclable.

The dimensioned containers and attachment members of the present invention can be dimensioned to accommodate different seat sites and configurations, and different articles to be carried. For example, suitable dimensions of a container include a width (left-to-right) of about 9 inches to about 30 inches, a length (front-to-rear) of about 12 inches to about 36 inches, and a depth of about 4 inches to about 12 inches. A suitable a retaining member that is generally rectangular may comprise a width of about 4 inches to 30 inches, a length of about 12 inches to 42 inches, and a thickness of about 1/16 of an inch to about ½ an inch, and a rearward, distal portion which extends upwardly, downwardly or both about ¼ inch to about 1½ inches preferably about ⅜ inch to 1 inch, and most preferably about ⅝ inch. The elastic retainer may comprise a width of about ½ inch to 2 inches and a length of about 6 inches to about 40 inches. Other dimensions may be used as desired.

1. A container for use with a vehicle seat comprising a backrest comprising at least a forward surface and a rear surface, a seat cushion comprising at least an upper surface and a rear surface, and a slot between said backrest and said seat cushion comprising:
a housing;
means for removably securing said housing to said vehicle seat, said securing means connected to said housing, extending rearwardly from said housing, and comprising a rearward distal portion comprising a resilient fluke which, after insertion into said slot, tends to open to better engage at least one of said surfaces in response to a forwardly directed force.

2. A container for use with a vehicle seat according to claim 1 wherein said rearward distal portion comprises a flexible material.

3. A container for use with a vehicle seat according to claim 1 wherein said rearward distal portion extends downwardly to engage said upper surface of said seat cushion.

4. A container for use with a vehicle seat according to claim 1 wherein said rearward distal portion extends downwardly to engage said rear surface of said seat cushion.

5. A container for use with a vehicle seat according to claim 1 wherein said securing means comprises a general planar proximal portion and wherein said rearward distal portion comprises a portion which is in overlapping relation with another portion of said rearward distal portion.

6. A container for use with a vehicle seat according to claim 5 wherein said rearward distal portion comprises a first portion which extends further downwardly than a second portion.

7. A container for use with a vehicle seat according to claim 6 wherein said rearward distal portion extends further downwardly in a center portion than in at least one edge portion.

8. A container for use with a vehicle seat according to claim 1 wherein said rearward distal portion comprises a bendable material which is folded into a generally overlapping relation and secured to itself proximate at least one edge.

9. A container for use with a vehicle seat according to claim 8 wherein at least one portion of said rearward distal portion is secured to a second portion of said rearward distal portion proximate at least one edge.

10. A container for use with a vehicle seat according to claim 9 wherein said securing means comprises a corrugated plastic.

11. A container for use with a vehicle seat according to claim 2 wherein said securing means comprises a generally flat body and opposite side edges, and wherein said rearward distal portion comprises a first portion which is folded back and secured to a second portion of said rearward distal portion proximate at least one of said edges such that at least one of said rearward distal portion edges does not engage as much of one of said rear surfaces as a center portion of said rearward distal portion.

12. A container for use with a vehicle seat according to claim 11 wherein said rearward distal portion is secured to a second portion of said rearward distal portion proximate both edges.

13. A container for use with a vehicle seat according to claim 1 wherein said securing means comprises a generally flat body and wherein said rearward distal portion comprises a first portion which is folded back and secured to a second portion of said rearward distal portion such that at least one portion of said rearward distal portion does not engage as much of one of said surfaces as another portion of said rearward distal portion.

14. A container for use with a vehicle seat according to claim 1 wherein at least a portion of said rearward distal portion extends generally perpendicular to an extension of the portion of said securing means passing through said slot.

15. A container for use with a vehicle seat according to claim 1 wherein at least a portion of said fluke forms an angle of about 20° to less than about 90°.

16. A container for use with a vehicle seat according to claim 1 wherein said rearward distal portion comprises at least one downwardly sloping edge to facilitate removal of said container from a vehicle seat.

17. A container for use with a vehicle seat according to claim 1 wherein said rearward distal portion comprises two downwardly sloping edges to facilitate removal of said container from a vehicle seat.

18. A container for use with a vehicle seat according to claim 1 further comprising a plurality of latches for releasably securing items to said housing.

19. A container for use with a vehicle seat according to claim 18 wherein said latches are disposed at different heights to facilitate releasably securing items of different sizes.

20. A container for use with a vehicle seat according to claim 1 further comprising an elongated, elastic member comprising a first end and a second end, said housing comprising a first means for securing said second end in a storage position and a second means for securing said second end in an operative position to secure an item to said housing.

21. A container for use with a vehicle seat according to claim 20 wherein at least one of said first and second securing means comprises a slot in said housing.

22. A container for use with a vehicle seat according to claim 20 wherein said second securing means comprises a slot on a forward portion of said housing.

23. A container for use with a vehicle seat according to claim 20 wherein said first securing means comprises a slot on a side portion of said housing.

24. A container for use with a vehicle seat according to claim 1 wherein said securing means comprises two sheets connected with intermediate ribs.

25. A container for use with a vehicle seat according to claim 24 wherein said intermediate ribs create alternating ridges and grooves between said sheets.

26. A container for use with a vehicle seat according to claim 1 wherein said securing means comprises a corrugated plastic.

27. A container for use with a vehicle seat according to claim 1 wherein said rearward distal portion comprises a height of about ¼ inch to about 1½ inches.

28. A container for use with a vehicle seat according to claim 1 wherein said rearward distal portion comprises a height of about ⅜ inch to about 1 inch.

29. A container for use with a vehicle seat according to claim 1 wherein said rearward distal portion comprises a height of about ⅝ inch.

30. A container for use with a vehicle seat according to claim 1 further comprising at least two latches wherein said latches are pivotable about axes located at different heights.

31. A container for use with a vehicle seat according to claim 1 further comprising a strap comprising at least two ends, wherein one end is affixed to said housing and a second end comprises an attachment member.

32. A container for use with a vehicle seat according to claim 31 wherein said attachment member comprises a hook.

33. A container for use with a vehicle seat according to claim 31 wherein said strap is stretchable.

34. A container for use with a vehicle seat according to claim 31 wherein said free end is removably securable to a plurality of portions of said housing with said attachment member.

35. A container for use with a vehicle seat comprising a backrest comprising at least a forward surface and a rear surface, a seat cushion comprising at least an upper surface and a rear surface, and a slot between said backrest and said seat cushion comprising:
a housing;
means for removably securing said housing to said vehicle seat,
a plurality of latches for releasably securing items to said housing,
wherein said latches are disposed at different heights to facilitate releasably securing items of different sizes to said housing.

36. An attachment member for securing a container to a vehicle seat comprising a backrest comprising at least a forward surface and a rear surface, a seat cushion comprising at least an upper surface and a rear surface, and a slot between said backrest and said seat cushion comprising:
a top portion comprising means for attaching a portion of said attachment member to a container, an intermediate portion dimensioned to extend through said slot, and a rearward distal portion which extends at an angle to said intermediate portion to engage at least one of said rear surfaces.

37. An attachment member for securing a container to a vehicle seat according to claim 36 wherein said attaching means comprises at least one rivet.

38. An attachment member for securing a container to a vehicle seat according to claim 36 wherein said attaching means comprises an adhesive.

39. An attachment member for securing a container to a vehicle seat according to claim 38 wherein said top portion of said attachment member comprises a peel away strip covering said adhesive portion, and wherein said peel away strip is selectively removable prior to connecting said attachment member to said container.

40. An attachment member for securing a container to a vehicle seat according to claim 36 wherein said attachment member comprises cardboard.

41. An attachment member for securing a container to a vehicle seat according to claim 39 wherein said attachment member comprises corrugated cardboard.

42. An attachment member for securing a container to a vehicle seat according to claim 36 wherein said attachment member comprises a thermoplastic material.

43. An attachment member for securing a container to a vehicle seat according to claim 36 wherein said attachment member comprises a recyclable thermoplastic material.
